(19) United States
(12) Patent Application Publication
(10) Pub. No.: US 2002/0143769 A1
(43) Pub. Date: Oct. 3, 2002

(54) Automatic content generation for images based on stored position data

(76) Inventors: Kirk Tecu, Greeley, CO (US); William Robert Haas, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/816,993

(22) Filed: Mar. 23, 2001

(51) Int. Cl. G06F 7/00

(52) U.S. Cl. 707/10

(57) ABSTRACT

A server receives image data and associated position data from a client. The server includes a position data database and at least one content database, where the content stored in the content database is associated with locations identified with position data. The server queries the position data database to determine the name of the location identified by the position data, and queries at least one content database based on the identified location. The image data is then annotated with the results of the content database query and/or the name of the location identified by the position data. Time data also may be associated with the image data. The server queries at least one content database based on the time data, and annotates the image data with the results of the content database query.

### BACKGROUND

This invention relates to photography, and more particularly to the addition of content to image data based on position data associated with the image.

In recent years, digital cameras have grown more popular. Some digital cameras include a broadcast position data receiver for imprinting position data on photographs taken by the camera. Referring to FIG. 1, a schematic of a digital camera 100 having a broadcast position data receiver 104 is shown. Image data is collected by an image acquisition device 102, such as a charge-coupled device (CCD) or complementary metal-oxide semiconductor (CMOS) chip. That image data is transmitted to a processor 106, which routes that image data into a data storage unit 110 such as a removable disk drive or random-access memory (RAM). The camera 100 also may include a clock 108 that prints on a photograph or stores the time that a picture was taken.

The broadcast position data receiver 104, such as a global positioning system (GPS) receiver, determines the position of the camera 100 at the time a picture is taken, and transmits that position data to the processor 106. The processor 106 routes that position data to the data storage unit 110, storing that position data in association with the image data. Later, when a photograph is displayed or printed, that position data is superimposed on a portion of the image. It is also known to imprint position information onto photographic film utilizing a film camera having a position data receiver 104, in the same manner as date information is imprinted on standard photographic film. Position data is given in terms of longitude and latitude coordinates, which by themselves convey little or no meaning to consumers, and which require a person viewing the image to perform additional research to discover the actual location where the photograph was taken.

### SUMMARY

A server receives image data in conjunction with position data, and annotates the image data with content relating to the position data.

In one aspect of the invention, a server receives image data and associated position data. The server includes a location database and at least one content database. The server queries the location database to determine the name of the is location identified by the position data, and queries at least one content database based on the identified location.

In another aspect of the invention, the server annotates the image data with the results of the content database query and/or the name of the location identified with the position data. In this way, the image data is enhanced with additional information relating to the location where the image was captured.

In another aspect of the invention, time data also may be associated with the image data. The server queries at least one content database based on the time data and annotates the image data with the results of the content database query. In this way, the image data is enhanced with additional information relating to the time the image was captured.

The invention will be more fully understood upon consideration of the detailed description below, taken together with the accompanying drawings.

### BRIEF DESCRIPTION OF THE DRAWINGS

FIG. 1 is a block diagram of a prior art digital camera having a broadcast position data receiver.

FIG. 2 is a schematic of a client/server system adapted to process image and position data.

FIG. 3 is a flow chart of a method of automatic content generation for images based on broadcast position data.

FIG. 4 is a schematic of a photographic data block.

FIG. 5 is an exemplary annotated image produced by the method of FIG. 3.

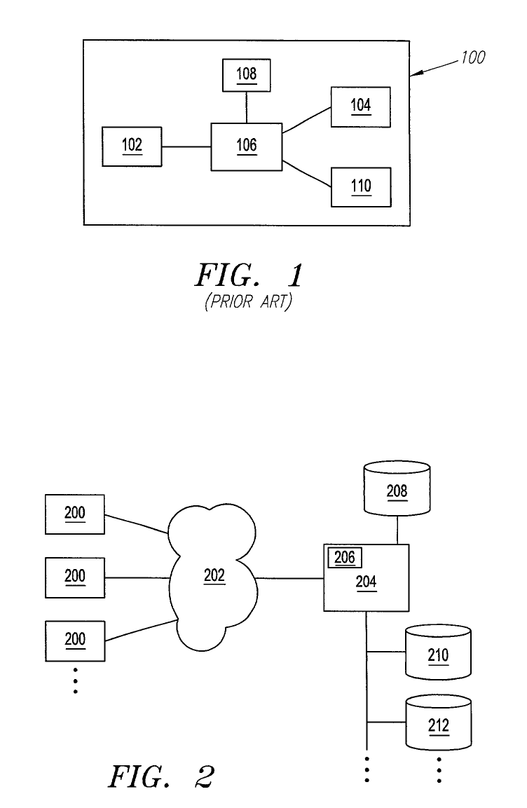

Use of the same reference symbols in different figures indicates similar or identical items.

### DETAILED DESCRIPTION OF THE PREFERRED EMBODIMENTS

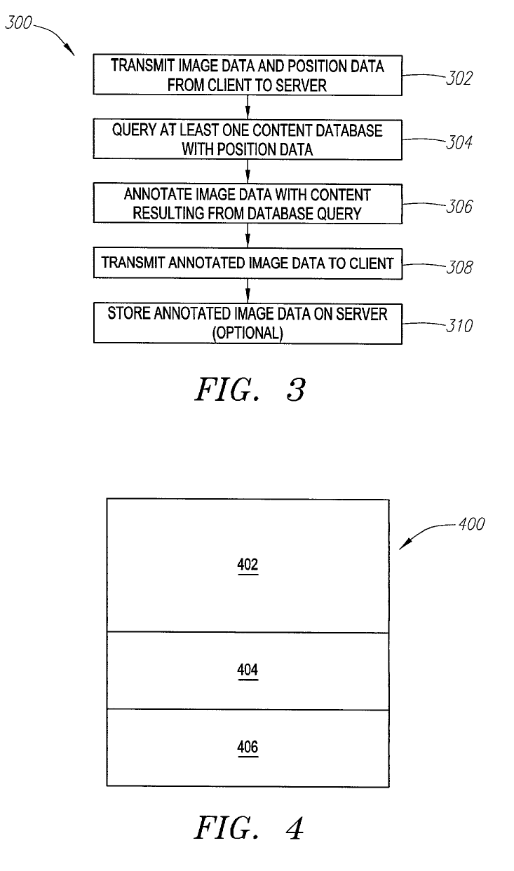

Referring to FIG. 2, one or more clients 200 are connected to a server 204 via a communications network 202 such as the Internet, in a standard client/server configuration. Each client 200 is an information handling system, such as a personal computer, Internet appliance, personal digital assistant, wireless telephone, web-enabled camera, or other device. The server 204 is an information handling system as well, preferably a standard computing device specifically designed for use as a server 204. The connections between each client 200 and the communications network 202, and the server and the communications network 202, may be made by any mutually compatible physical structure and transmission protocol.

A data storage device 206 may be included within or associated with the server 204. The data storage device 206 may cache or otherwise temporarily store data received from one or more clients 200. The data storage device 206 may be a hard drive, a hard drive array, random-access memory, or any other type of storage device. The server 204 also is connected to databases 208, 210, 212. The databases 208, 210, 212 may be stored on the server 204, on another information handling system, or on a storage device dedicated to the server 204 or shared over a network. The particular locations of the databases 208, 210, 212, and the type of devices used to store the databases 208, 210, 212, are not critical to the invention. The location database 208 stores location names corresponding to particular position data, such that a particular location name may be matched to a particular set of position data. The content databases 210, 212 include content associated with particular locations, such that specific content may be matched to a specific location. While only two content databases 210, 212 are shown, more content databases maybe provided if desired. Further, only a single content database may be provided, if desired.

Referring as well to FIG. 3, a method 300 is shown for automatically generating content for images based on corresponding position data. In step 302, image data and position data are transmitted from a client 200 to the server 204, for example over a communications network 202, such as the Internet. Referring also to FIG. 4, the image data and position data are transmitted to the server 204 as components of a photographic data block 400. The photographic data block 400 includes image data 402 that encodes a single photographic image taken by the camera 100. The image data 402 may be in any format useful for encoding image data, such as GIF or JPEG format.

The photographic data block 400 also includes position data 404 that encodes the position of the camera 100 at the time the image data 402 was captured. That is, when a picture is taken the camera 100 captures both image data 402 and position data 404. The position data 404 may be in the form of longitude and latitude coordinates, as determined by the position data receiver 104 in the camera 100. The conversion of broadcast position data to longitude and latitude coordinates is standard in the art. However, the position data 404 may be raw broadcast position data, such as raw GPS data. Optionally, the photographic data block 400 includes chronological data 406 as well. The chronological data 406 encodes the time that the image data 402 was captured by the camera 100. The chronological data 406 may include both the date and time of day determined at the time the image data 402 is captured, for example by reference to the clock 108 within the camera 100. Optionally, the chronological data 406 may be obtained from broadcast time information, as is known in the art. The photographic data block 400 is stored within the data storage unit 110 of the camera 100.

The photographic data block 400 may be transmitted from the client 200 to the server 204 as a single file, or as multiple sets of data associated together by common headers or other identifying information. That is, while the photographic data block 400 is shown in FIG. 4 as a contiguous entity to facilitate its description, the data within the photographic data block 400 need not be stored together as a contiguous entity. The photographic data block 400 may be provided to the server 204 from the camera 100 in a number of different ways. In one embodiment, the data storage unit 110 is a removable hard disk drive or other such drive, capable of holding a removable storage device which can be taken out of the camera 100 and inserted into an information handling system such as an Internet appliance, personal computer or the like, which acts as the client 200. In another embodiment, the camera 100 is connected to a client 200 via a cable or by a wireless data transfer device, thereby allowing data transfer from the camera 100 to the client 200, then to the server 204, without the need to use removable media within the camera 100.

In another embodiment, the camera 100 acts as a client 200, in which case the photographic data block 400 may be transmitted directly from the data storage unit 110 to the server 204 by way of the Internet 202. The data storage unit 110 or the camera 100 may include a connector for accepting a cable, or may include wireless data transfer capabilities, for transferring the photographic data block 400 out of the data storage unit 110.

Next, in step 304, the photographic data block 400 received from the client 200 is cached or otherwise temporarily stored in the data storage device 206 in the server 204. The server 204 then queries the location database 208 with the position data 404 received from the client 200 and stored in the data storage device 206.

As discussed above, the location database 208 may be a relational database, and includes a number of location names associated with position data. As used in this document, the term “location” refers to the common name of a particular set of geographic coordinates, and the term “position” refers to the set of geographic coordinates themselves. In response to the query, the location database 208 returns a location name associated with the position data 404 used in the query. Database query and response are standard in the art. That location name is then stored in the data storage device 206 in conjunction with the image data 402 and the position data 404. Thus, by querying the location database 208 with the specific position data 404 associated with a particular image in a photographic data block 400, a location name corresponding to the particular image data 402 in the photographic data block 400 can be determined. In the event that no location name corresponding to the position data 404 is stored within the location database 208, then the database returns no location name information, and the process 300 stops. In another embodiment, the location database 208 includes location names associated with raw broadcast position data.

The server 204 additionally queries a content database 210, 212 with the location name associated with the position data 404. The content database 210 includes content relevant to particular locations. For example, the content database 210 may include map information, weather information, event information, or news information, where each item of information is associated with one or more location names.

In one exemplary embodiment, the content server 210 includes map information. The server queries the content database 210, which returns a map of the location name used to query that database.

In another exemplary embodiment, the content database 210 is a weather database that includes present or historical weather information. The server queries the content database 210, which returns weather information relating to the location name used to query that database.

In another exemplary embodiment, the database 210 includes news items, each of which is associated with a particular dateline or location. The server 204 queries the database 210 with a location name, and a news story relating to that location is returned.

In another exemplary embodiment, the content database 210 includes event information, where the server 204 queries the content database 210 with a location name, and a list of events in that vicinity, such as conventions or festivals, is returned.

In another exemplary embodiment the content database 210 includes real estate information. The server 204 queries the content database 210 with the location name, and information about real estate in the vicinity of the location is returned. Real estate information may include real estate for sale, recent sales, neighborhood information, or other information.

In another exemplary embodiment, the content database 210 includes advertisements specific to a particular area, such that when the server 204 queries the content database 210 with a location name, an advertisement specific to that location is returned to the data storage device 206. For example, an advertisement for a restaurant, theme park, or some other business near at or near the location may be returned to the data storage device 206. These exemplary embodiments merely illustrate certain types of content that may be stored in the content database 210, and are not limiting.

The content stored in the content database 210 may be in the form of text, audio data, video data, computer code or any other sort of information that may be stored in the database. Content such as audio data, video data and computer code may include an associated text tag to facilitate database searching. Multiple content databases 210, 212 may be provided, such that multiple different types of content can be generated based on the location name used to query the databases 210, 212. Although only two content databases 210, 212 are shown in FIG. 2, additional content databases may be provided in order to allow for more types of content to be generated based on the location name.

Optionally, the server 204 also queries a content database 210, 212 with the time and/or date information included in the chronological data 406. The content database 210 includes content relevant to particular times and/or dates. For example, the content database 210 may include news information, where each item of news information is associated with a particular date. In this way, content can be returned to the server 204 based both on the location where, and the time and/or date when, a picture was taken.

In step 306, the image data 402 stored in the data storage device 206 is annotated with data received in response to the one or more database queries in step 304. In one embodiment, the server 204 annotates image data 402 from the data storage device 206 with content obtained in step 304 by generating a web page including the image data 402 and the retrieved content. The web page may include content superimposed upon, presented adjacent to, or otherwise arranged in conjunction with the image data 402. In another embodiment, the server 204 may combine the image data 402 with the content obtained in step 304 into a single image file such as a JPEG file. The annotated image preferably is stored temporarily in the server 204 before being served to a client 200.

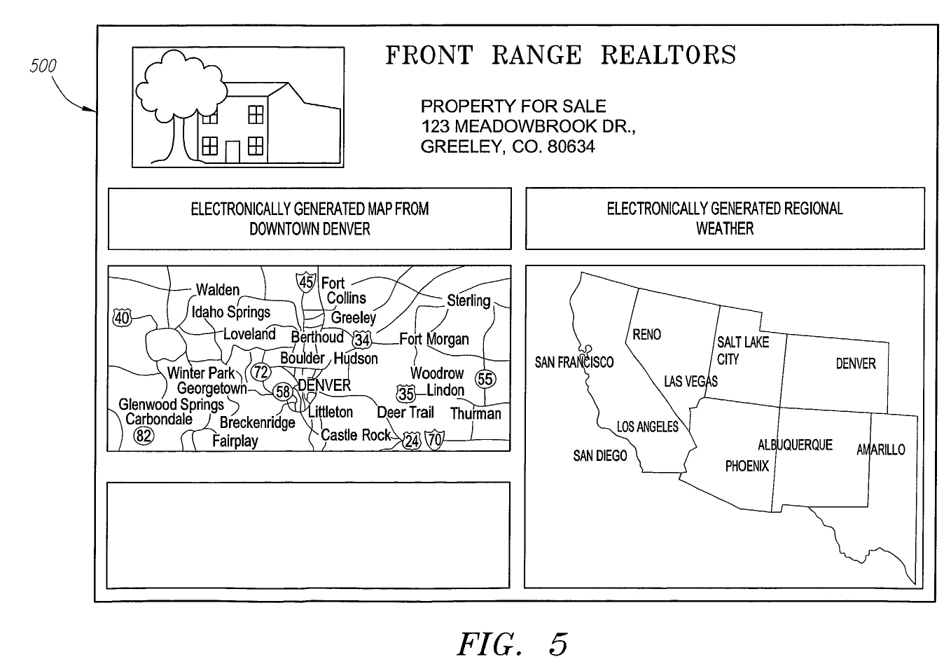

Next, in step 308, the server 204 transmits the annotated image to the client 200, preferably by serving it to the client 200 via the Internet 202. If in step 306 the server 204 generated a web page, then the server 204 serves that web page to the client 200. If in step 306 the server 204 generated a single annotated image file containing both image data 402 and content, then the server 204 serves that single annotated image file to the client 200. The annotated image data is served back to the same client 200 that originally transmitted and position data to the server 204. However, if desired, the server 204 may serve the annotated image data to one or more other clients 200. Serving a web page or file to a client from a server is known in the art. An exemplary annotated image 500 is shown in FIG. 5, where the annotated image 500 of a home for sale includes a map of the vicinity of the property, contact information for the realtor, and current weather information for the property. Alternately, the server 204 prints the annotated image on a printer (not shown) and ships the annotated image back to the user. In this way, the user can obtain a photographic print or other printed version of the image data 402, along with additional related content.

Step 310 is optional. In step 310, the annotated image data is stored on the server 204 such that it can be viewed by multiple clients 200. Access to such annotated image data may be public or conditional. Annotated image data that is publicly accessible may be viewed by any user at any client 200. To implement conditional access, the server 204 utilizes security measures, such as usernames and password protection, such that only selected users may access the annotated image data. For example, if a user wishes to retain personal vacation photographs on the server 204, the annotated images generated from those photographs may be password-protected such that only friends or family given the password by the user may view the annotated image data. The use of security measures such as user names and passwords is well known in the art. As another example, a realtor may take pictures of properties she is representing for sale, and store the annotated images 500 generated from those pictures on the server 204. In this example, public access may be granted to the annotated images 500 in order to enhance their sales and marketing effectiveness. The duration of storage of the annotated image data is not critical to the invention.

Although the invention has been described with reference to particular embodiments, the description is only an example of the invention's application and should not be taken as a limitation. Consequently, various adaptations and combinations of features of the embodiments disclosed are within the scope of the invention as defined by the following claims and their legal equivalents.

What is claimed is:

1. A method for providing content in association with image data, comprising:
receiving image data and associated position data;
retrieving content data related to said position data; and
producing an annotated image including said image data and said content data.

2. The method of claim 1, wherein said retrieving comprises:
identifying a location name corresponding to said position data;
querying at least one content database with said location name; and
receiving content data from said content database in response to said querying.

3. The method of claim 2, wherein said identifying a location name comprises:
querying a location database with said position data; and
receiving a location name from said location database in response to said querying.

4. The method of claim 1, wherein said content database comprises text.

5. The method of claim 1, further comprising:
receiving chronological data in association with said image data;
querying at least one content database with said chronological data; and
receiving content data from said content database in response to said querying;
wherein said annotated image includes data obtained from said content database in response to said query based on said chronological data.

6. The method of claim 1, further comprising serving said annotated image to a client.

7. The method of claim 5, wherein said serving comprises serving a web page to said client, said web page including said annotated image.

8. The method of claim 1, wherein said position data comprises longitude and latitude coordinates.

9. The method of claim 1, further comprising storing said annotated image.

10. The method of claim 9, further comprising granting conditional access to said stored annotated image.

11. The method of claim 1, further comprising printing said annotated image.

12. A method for providing content in association with image data, comprising:
receiving image data and associated position data;
querying a location database with said position data; and
receiving a location name from said location database in response to said querying.
querying at least one content database with said location name;
receiving content data from said content database in response to said querying;
producing an annotated image including said image data and said content data;
serving a web page to said client, said web page including said annotated image; and
storing said annotated image.

13. A system adapted to generate content in association with image data, comprising:
a location database;
a content database; and
a server connected to said location database and to said content database, said
server adapted to
receive image data and associated position data from a client,
retrieve content data from a content database, said content data related to said position data,
produce an annotated image including said image data and said content data, and
serve said annotated image to said client.
